(19) United States
(12) Patent Application Publication
(10) Pub. No.: US 2004/0068818 A1
(43) Pub. Date: Apr. 15, 2004

(54) Cleaning apparatus and roller

(75) Inventors: Jiun-Bo Wang, Shijr City (TW); Chung-Min Lin, Taipei (TW); Shan Chang Wang, Taoyuan Hsien (TW); Chih-Kun Chen, Taoyuan (TW)

Correspondence Address: Quintero Law Office, 3rd Floor, 1617 Broadway, Santa Monica, CA, 90404, US

(73) Assignee: Nanya Technology Corporation

(21) Appl. No.: 10/614,911

(22) Filed: Jul. 8, 2003

(30) Foreign Application Priority Data
Oct. 11, 2002 (TW) 91216187

(51) Int. Cl. B08B 1/04

(52) U.S. Cl. 15/230.18; 15/230; 15/102

(57) ABSTRACT

A cleaning roller. The roller comprises a shaft, a sponge sleeve, and an inflatable chamber. The sponge sleeve encloses the shaft, and the inflatable chamber is disposed between the shaft and the sponge sleeve. A central portion of the inflatable chamber is thicker than the ends of the inflatable chamber. The inflatable chamber is of elastic materials. By introducing a working flow into the inflatable chamber, the thickness of the central portion of the inflatable chamber can be adjusted.

### BACKGROUND OF THE INVENTION

1. Field of the Invention

The present invention relates to a roller, especially to a roller used in chemical mechanical polishing.

2. Description of the Related Art

In chemical mechanical polishing (CMP), particles frequently remain on a wafer surface after polishing. These particles decrease the quality and reliability of a final product. Thus, after polishing, the wafer is cleaned by a roller. As shown in FIG. 1, wafer 110 is rotated by motor driving PU chucks 130. The roller 120 is rotated by a motor 122 to clean the wafer surface.

FIG. 2 is a schematic diagram of a conventional roller. As shown in FIG. 2, the conventional roller 200 comprises a shaft 220 and a sponge sleeve 210. The sponge sleeve 210 encloses the shaft 220. As the roller 200 cleans a wafer 230, contact pressure with the wafer 230 at each contact point is the same. Because the tangent velocity of each contact point on the wafer 230 equals (rotation speed)×(rotation radius), the contact points on the edges of the wafer 230 have the highest tangent velocity and the contact point at the center has a tangent velocity equal to zero. For this reason, the roller has poorer cleaning ability at its center than at the ends.

As well, as shown in FIG. 3, after being used for a period, the sponge sleeve 210 compresses, forming an indentation in the center of the sponge sleeve surface. The indentation decreases or prevents contact pressure between the roller and the wafer 230.

### SUMMARY OF THE INVENTION

For these reasons, there is a clear need for a roller with uniform and stable cleaning ability. The roller comprises a shaft, a sponge sleeve, and an inflatable chamber. The sponge sleeve encloses the shaft. The inflatable chamber is disposed between the shaft and the sponge sleeve. A central portion of the inflatable chamber is thicker than the ends. The inflatable chamber is of elastic materials. By introducing a working flow into the inflatable chamber, the thickness of the central portion of the inflatable chamber can be adjusted.

The present invention increases contact pressure between the roller and the wafer, especially in the center of the wafer. Thus, the entire wafer can be cleaned uniformly. As well, the present invention can compensate for the indentation of the sponge sleeve to maintain cleaning efficiency.

### BRIEF DESCRIPTION OF THE DRAWINGS

The present invention can be more fully understood by reading the subsequent detailed description and examples with references made to the accompanying drawings, wherein:

FIG. 1 is a top view of a conventional roller cleaning apparatus;

FIG. 2 is a schematic diagram of a conventional roller;

FIG. 3 is a schematic diagram of a conventional roller with sleeve degradation;

FIG. 4 is a schematic diagram of the first embodiment;

FIG. 5 is a schematic diagram of the second embodiment;

FIG. 6a shows particle distribution of a wafer after being cleaned by the conventional roller;

FIG. 6b shows particle distribution of a wafer after being cleaned by the present invention; and

FIG. 7 is a diagram comparing cleaning efficiency of the conventional roller with that of the present invention.

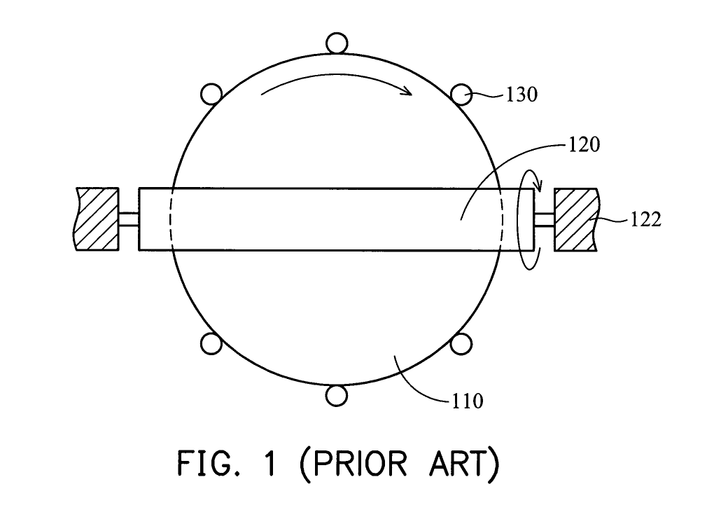

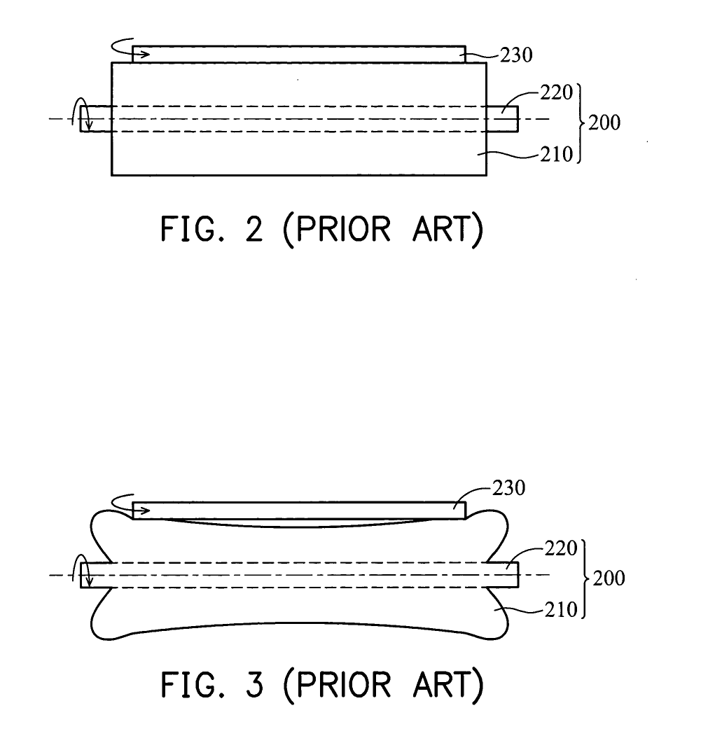

### DETAILED DESCRIPTION OF THE INVENTION

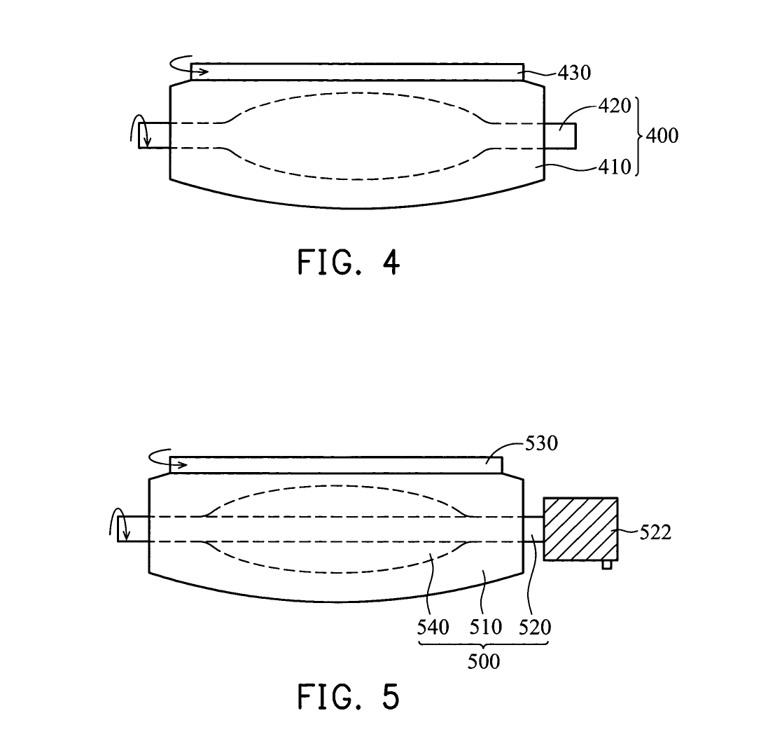

FIG. 4 shows the first embodiment of the present invention. As shown in FIG. 4, the roller 400 comprises a shaft 420 and a sponge sleeve 410. The sponge sleeve 410 encloses the shaft 420. A central portion of the shaft 420 is thicker than the ends. The first embodiment directly increases contact pressure between the central portion of the roller and the wafer 430 to provide uniform cleaning of the wafer. As well, despite sponge sleeve 410 degrading with use, the central portion of the roller 400 is still thicker than the ends. Thus, the fist embodiment keeps the sponge sleeve 410 in sufficient contact with the wafer 430.

FIG. 5 shows the second embodiment of the present invention. As shown in FIG. 5, the roller 500 comprises a shaft 520, a sponge sleeve 510, and an inflatable chamber 540. The sponge sleeve 510 encloses the shaft 520. The inflatable chamber 540 is disposed between the shaft 520 and the sponge sleeve 510. A central portion of the inflatable chamber 540 is thicker than the ends of the inflatable chamber 540. The inflatable chamber 540 is of elastic materials. By introducing a working flow into the inflatable chamber 540, the thickness of the central portion of the inflatable chamber 540 can be adjusted. The working flow can be air. In this way, contact pressure is maintained between the roller and the wafer. As well, compensation for degradation of the sponge sleeve is accomplished by introducing the working flow into the inflatable chamber. Thus, the life time of the roller is extended.

The roller 500 cleans the wafer 530 with a rotational motion. In order to introduce the working flow into the inflatable chamber 510 without twisting a supply tube (not shown), a rotary joint 522 can be disposed between the roller 500 and a supply apparatus (not shown). Thus, the present invention can also constitute a cleaning apparatus comprising the roller mentioned above, a rotary joint and a supply apparatus.

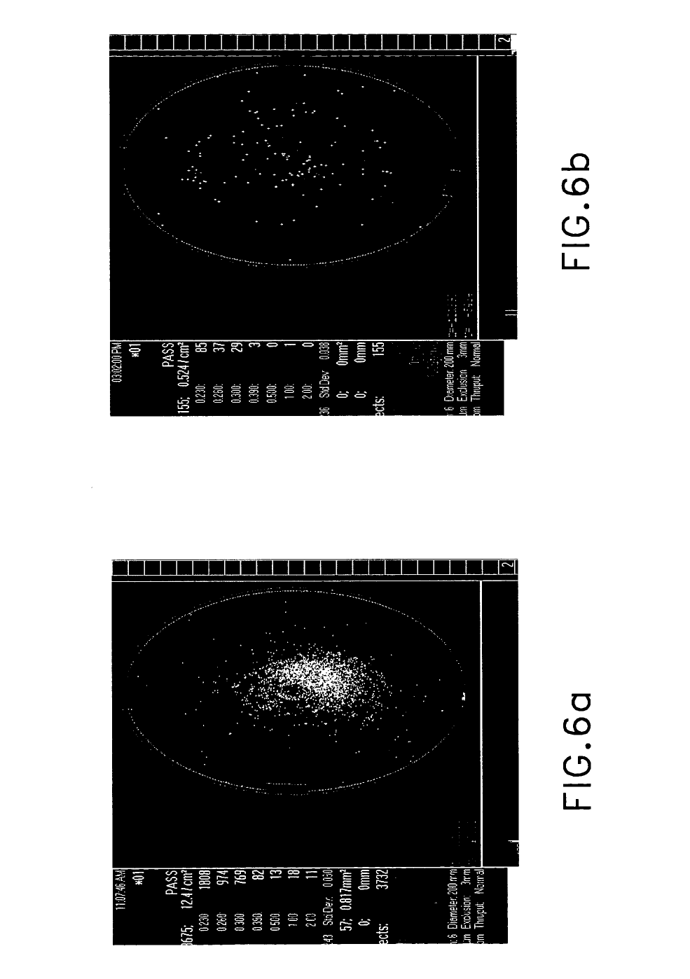

FIG. 6a shows particle distribution of a wafer after being cleaned by the conventional roller. In FIG. 6a, the particles are concentrated in the center of the wafer. FIG. 6b shows particle distribution of a wafer after being cleaned by the present invention. In FIG. 6b, the particles' distribution is more uniform than in FIG. 6a. As well, the particle count shown in FIG. 6b is obviously lower than in FIG. 6a.

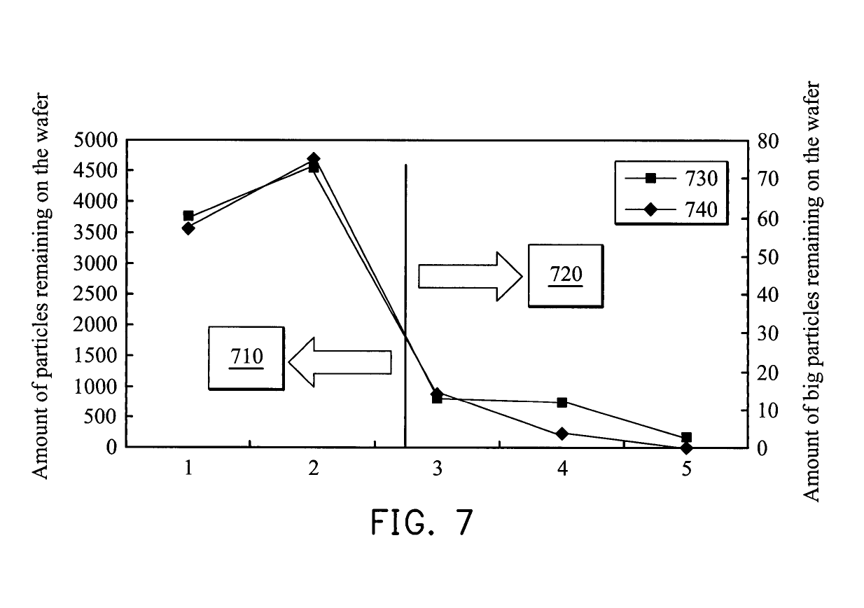

FIG. 7 is a diagram comparing the cleaning efficiency of the conventional roller with that of the present invention. In FIG. 7, an area 710 shows a cleaning result of the conventional roller, and an area 720 shows a cleaning result of the present invention. The horizontal axis represents independent experiment results. Curve 730 shows an amount of particles remaining on the wafer. Curve 740 shows an amount of large particles remaining on the wafer. Curve 730 shows that with the conventional roller, 3500˜5000 particles remain on the wafer, and with the present invention, 200˜1000 particles remain on the wafer. Curve 740 shows that with the conventional roller, 60˜80 large particles remain on the wafer, and with the present invention, 0˜20 large particles remain on the wafer. The comparison mentioned above demonstrates that the present invention provides obvious improvement in cleaning ability.

The present invention thus increases contact pressure between the roller and the wafer, especially in the center of the wafer. Thus, the entire wafer is cleaned uniformly. As well, the present invention can compensate for the indentation of the sponge sleeve, maintaining cleaning efficiency of the roller.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A roller comprising:
a shaft; and
a sponge sleeve, enclosing the shaft;
wherein a central portion of the shaft is thicker than the ends of the shaft.

2. A roller comprising:
a shaft;
a sponge sleeve, enclosing the shaft; and
an inflatable chamber, disposed between the shaft and the sponge sleeve, a central portion thereof thicker than the ends thereof.

3. The roller as claimed in claim 2, wherein the inflatable chamber is of elastic materials.

4. The roller as claimed in claim 3, wherein by introducing a working flow into the inflatable chamber, the thickness of the central portion of the inflatable chamber is adjustable.

5. The roller as claimed in claim 4, wherein the working flow is air.

6. A cleaning apparatus comprising:
the roller as claimed in claim 4;
a rotary joint, disposed on the roller; and
a supply apparatus, connected to the rotary joint.
